(19) United States
(12) Patent Application Publication
(10) Pub. No.: US 2017/0174053 A1
(43) Pub. Date: Jun. 22, 2017

(54) REINFORCED MOTOR VEHICLE DOOR

(71) Applicant: RENAULT s.a.s., Boulogne Billancount (FR)

(72) Inventor: Laurent PRUVOST, Bercheres Sur Vesgre (FR)

(73) Assignee: RENAULT s.a.s., Boulogne Billancount (FR)

(21) Appl. No.: 15/312,466

(22) PCT Filed: May 21, 2015
(86) PCT No.: PCT/FR2015/051339

§ 371 Date: Nov. 18, 2016

(30) Foreign Application Priority Data
May 21, 2014 (FR) 1454562

(51) Int. Cl. B60J 5/04

(52) U.S. Cl. CPC B60J 5/0451

(57) ABSTRACT

A motor vehicle door includes an exterior panel, a control to open the door, a device to reinforce the door with an adhesive sandwich plate made up of sheets of composite materials to be bonded to an interior part of the exterior panel, and a rigid section piece bonded to the sandwich plate and made of composite materials.

The present invention relates to a motor vehicle door.

European regulation ECE 95 dictates that, whatever the type of motor vehicle, the doors must not open in a side impact. Now, it is found that the control for opening from the outside, which is placed on the exterior face of the door, causes unwanted opening when, in a crash, the metal work crumples underneath it and pushes this handle in the direction of opening, as a hand would do.

Unfortunately, the solutions capable of avoiding such deformation are few in number and have disadvantages.

One of the solutions is to arrange the entire control for opening in a pressed concave shape. However, this has a significant impact on the look of the vehicle. For this reason, this solution is little used because it is considered unattractive.

The other solution is to add an adhesive sandwich plate of greater or lesser thickness made up of sheets of composite material under or around the control for opening. This type of sandwich plate is marketed under the tradename “BETABRACE®”, amongst others. This solution is not restrictive from an aesthetic standpoint but is technically less effective because this sandwich plate lacks stiffness and is more flexible than the first solution. It should be pointed out that these sandwich plates come in different thicknesses but that the thickest ones are not sufficiently stiff.

The present proposed invention therefore seeks to limit this deformation in order to avoid this phenomenon whereby the handle is propelled inward by a crumpling of the metal work of the door and to eliminate the metal work deformations that occur just behind the control for opening on the exterior door panel.

The door according to the invention comprises an exterior panel, a control for opening and a device for reinforcing a motor vehicle door with an adhesive sandwich plate made up of sheets of composite materials which is intended to be bonded to an interior part of the exterior panel; the device is characterized in that it comprises a rigid section piece bonded to the sandwich plate made of composite materials. The section piece allows the sandwich plate to be reinforced and the adhesive nature of the plate allows the section piece to be held in position without the need for welding which would have a negative effect on the external appearance of the door.

Advantageously, the section piece is made of metal. This type of section piece is relatively economical to produce. It will preferably have the same composition as the exterior panel of the door.

According to a first alternative form, the section piece is tubular.

According to a second alternative form, the section piece is produced by pressing. It is thus possible to produce any kind of profile: Ω-shaped, U-section, L-section, etc.

Advantageously, the section piece is positioned between the sandwich plate and the interior part of the exterior panel. The section piece is thus bonded to the sandwich plate which is itself bonded to the interior part of the exterior panel of the door, the section piece thus being held on the door.

According to one particular arrangement, the section piece is shorter than the sandwich plate and in that the section piece has at least one end covered by said plate. The section piece will thus be able to be completely covered by the sandwich plate and protected from dirt and moisture.

According to a second arrangement, the section piece is longer than the sandwich plate and in that the section piece has at least one end protruding beyond said plate. If the section piece is longer, it affords more extensive protection to the control for opening.

According to a third arrangement, the section piece is placed on at least one of the edges of the sandwich plate. The section piece is a U-section or an L-section and one of its faces will be bonded on the adhesive side to one edge of the sandwich plate which will hold it in position. In the case of a U-section section piece, the legs of the U may grip the sandwich plate and thus likewise be held in position on said plate. The section piece may go all around the sandwich plate.

Advantageously, the sandwich plate has an opening and the section piece is placed along at least one of the edges of said opening. In this case, the U-section or L-section section piece is placed inside the opening.

Advantageously, the sandwich plate has an opening through which the section piece passes. In the case of a round or square or Ω-section tubular section piece, this section piece will pass through the sandwich plate and there will be at least one part positioned on the adhesive side of the sandwich plate. There may for example be a first part positioned on the non-adhesive side of the plate, a second part placed on the adhesive side and a third part on the non-adhesive side, the section piece being threaded through the plate like a needle through fabric.

The invention also relates to a vehicle equipped with a door with at least one of the above features.

Further advantages may further become apparent to a person skilled in the art from reading the examples given herein below, which are illustrated by the attached figures given by way of example:

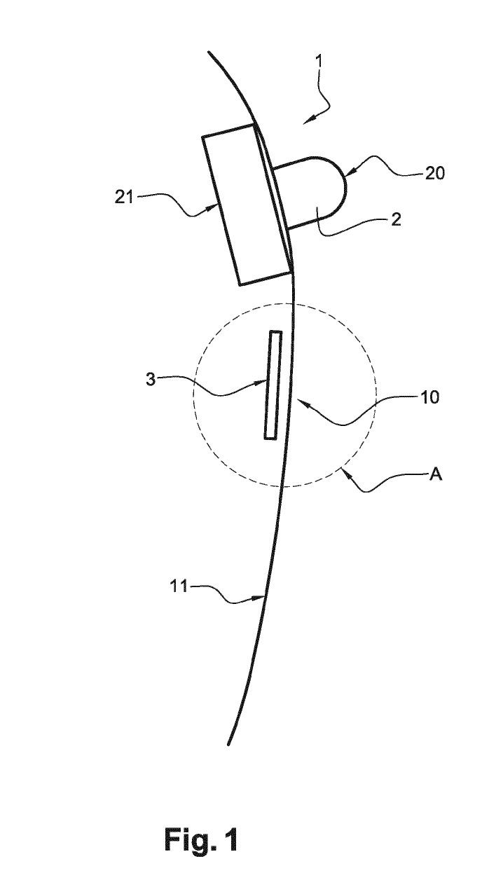

FIG. 1 is a side view of a door with a reinforced part of the prior art,

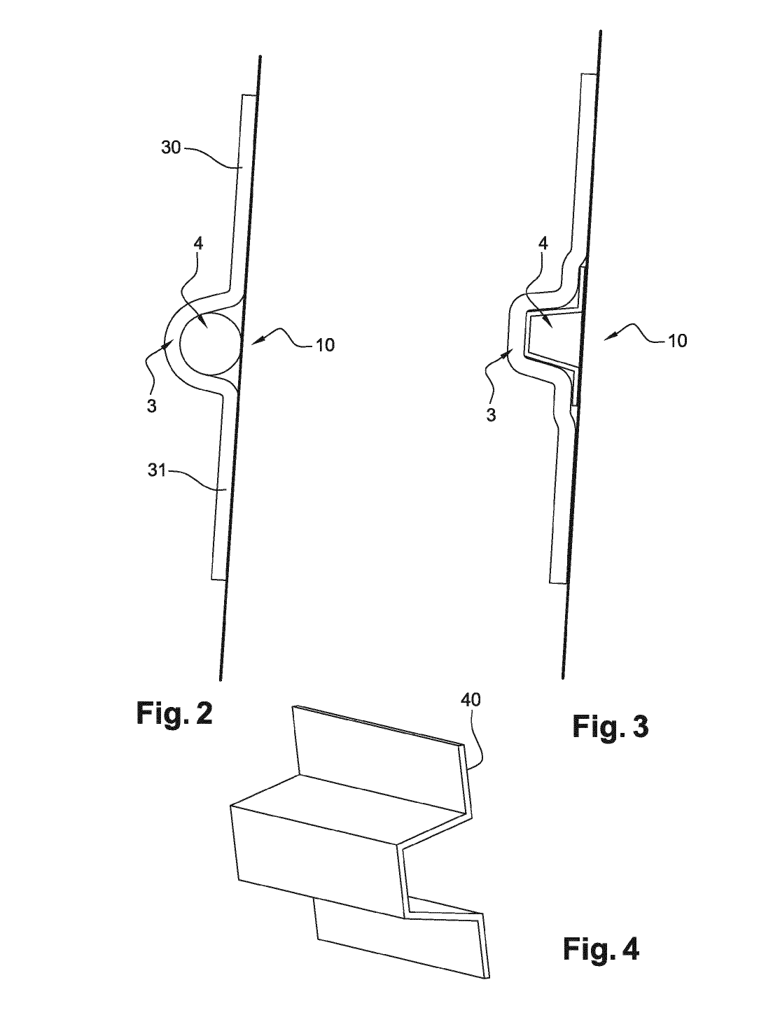

FIG. 2 is detail A of the reinforced part according to a first alternative form of the invention,

FIG. 3 is detail A of the reinforced part according to a second alternative form,

FIG. 4 is a perspective view of one example of section piece,

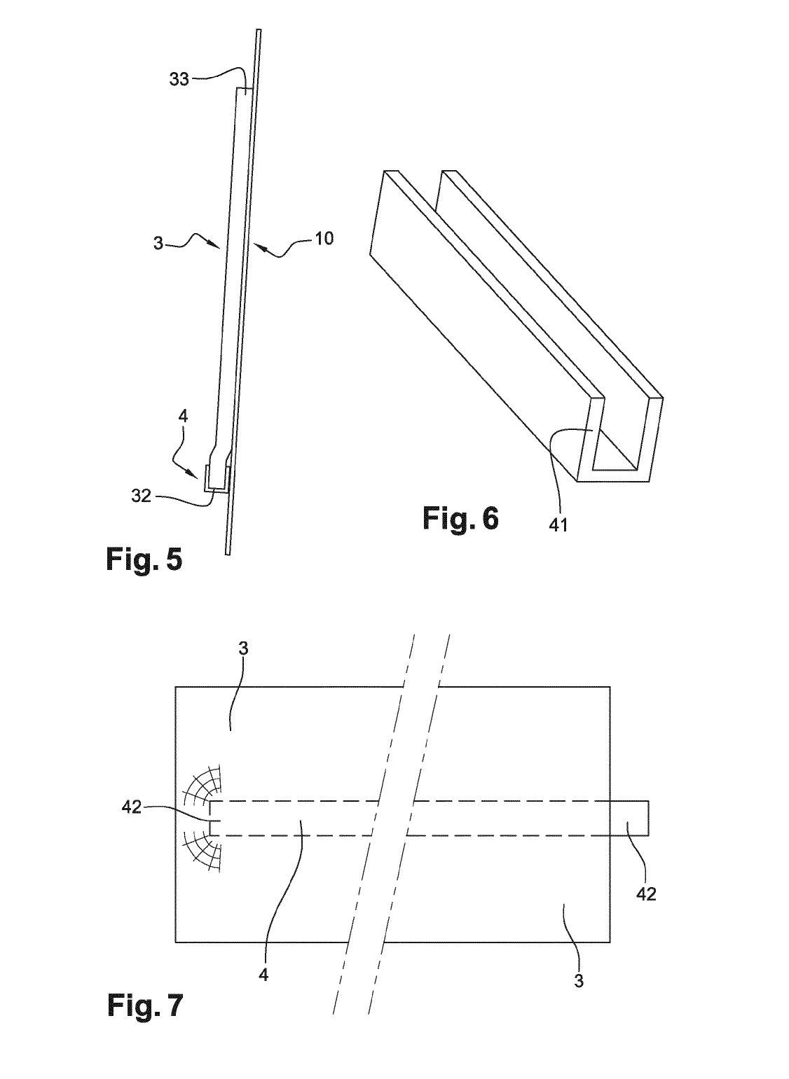

FIG. 5 is detail A of the reinforced part according to a third alternative form,

FIG. 6 is a perspective view of another example section piece,

FIG. 7 is a view of the reinforced part from the inside of the door,

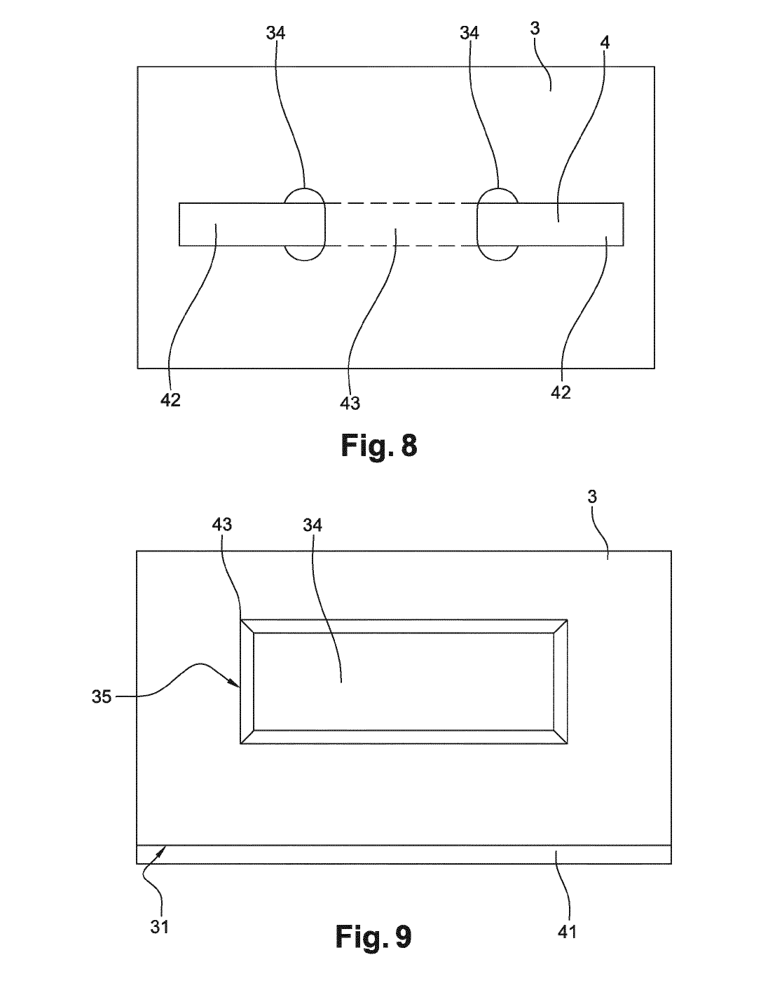

FIG. 8 is a view of one embodiment of the reinforced part from the inside of the door,

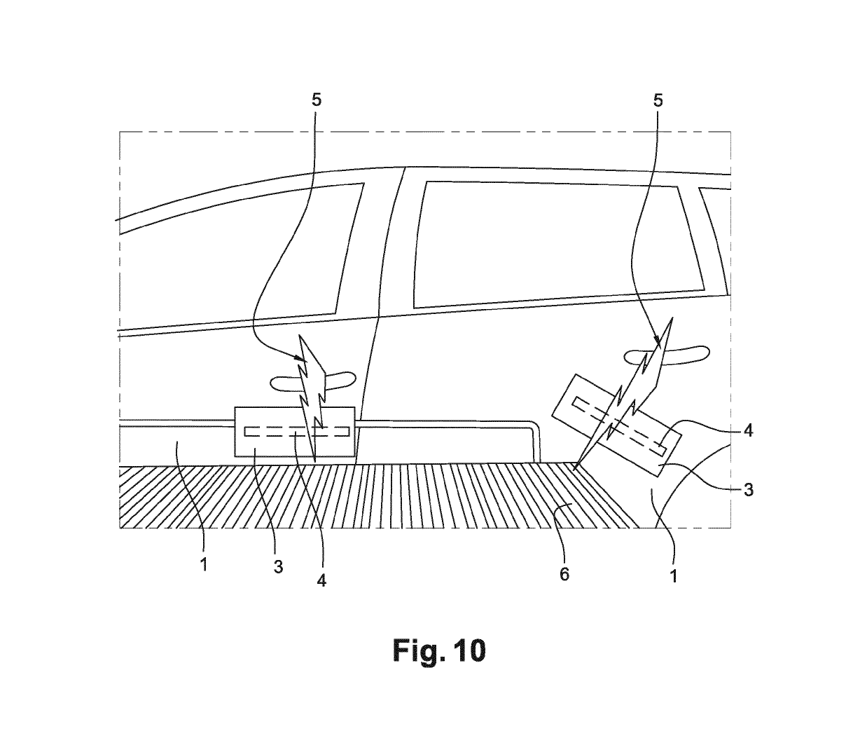

FIG. 9 is a view of another embodiment of the reinforced part from the inside of the door,

FIG. 10 is a side view of a vehicle equipped with the device.

The door 1 illustrated in FIG. 1 comprises an outer sheet or panel 10 with a control 2 for opening with a handle 20 for grasping which is arranged on the outside of the vehicle and a control mechanism 21 arranged on the inside of the outer panel of the door. In the remainder of the description it will be considered that the outside corresponds to the outside of the vehicle and therefore the outside of the door and the inside to the inside of the door. The top corresponds to the top in the figures and the bottom to the bottom in the figures. The door 1 also comprises an adhesive reinforcing plate 3 arranged on the inside of the door 1.

In the examples of FIGS. 2 and 3, the door 1 is reinforced by an adhesive plate 3 of substantially rectangular shape and a section piece 4 is placed between the interior part 11 of the exterior panel 10 and the plate 3. In FIG. 2, the section piece 4 is of tubular shape whereas in FIG. 3 it is in the shape of an Ω. The plate 3 takes the form of the section piece 4 and protrudes beyond said section piece 4 in its top part 30 and its bottom part 31.

In FIGS. 3 and 4, the section piece 40 may be produced by pressing.

In the example of FIG. 5, the section piece 41 is a U-section, likewise produced by pressing, and is placed around the lower edge 32 of the plate 3, but it could equally be placed around the upper edge 33, or even all around the plate 3.

The section piece 4 may be completely covered by the plate 3 as illustrated on the left-hand side of FIG. 7 or may protrude as shown on the right-hand side of FIG. 7, its ends 42 protruding beyond the plate 3. The section piece 4 may also finish flush.

The section piece 4 in FIG. 8 is threaded through the plate 3, which means to say that the ends 42 emerge from the plate 3 via holes 34 whereas the central part 43 of the section piece 4 is positioned under the plate in contact with the exterior panel 10. In this instance, the holes 34 are oval in shape but they could be square, rectangular or round for example.

In FIG. 9, the plate 3 is cut with a rectangular opening 34, but this opening could very well have some other shape. Here, the section piece 41 is in the form of a U section and is placed in the bottom part 31 of the plate, there is also a U-section section piece 43 along the entire interior edge 35 of the opening 34.

It may be seen in FIG. 10 that in a side impact from a sled 6, the doors 1 deform along the lines 5 so it is therefore preferable for the plates 3 to be arranged with the section pieces 4 at right angles to these lines 5 of deformation.

Other shapes of plate and section piece are possible without departing from the scope of the present invention.

1-11. (canceled)

12. A motor vehicle door, comprising:
an exterior panel;
a control to open the door;
a device to reinforce the door with an adhesive sandwich plate made up of sheets of composite materials to be bonded to an interior part of the exterior panel; and
a rigid section piece bonded to the sandwich plate and made of composite materials.

13. The door as claimed in claim 12, wherein the section piece is made of metal.

14. The door as claimed in claim 12, wherein the section piece is tubular.

15. The door as claimed in claim 12, wherein the section piece is produced by pressing.

16. The door as claimed in claim 12, wherein the section piece is positioned between the sandwich plate and the interior part of the exterior panel.

17. The door as claimed in claim 16, wherein the section piece is shorter than the sandwich plate and the section piece has at least one end covered by said plate.

18. The door as claimed in claim 16, wherein the section piece is longer than the sandwich plate and the section piece has at least one end protruding beyond said plate.

19. The door as claimed in claim 12, wherein the sandwich plate includes edges and the section piece is placed on at least one of the edges of the sandwich plate.

20. The door as claimed in claim 19, wherein the sandwich plate has an opening including edges and the section piece is placed along at least one of the edges of said opening.

21. The door as claimed in claim 12, wherein the sandwich plate has an opening through which the section piece passes.

22. A vehicle comprising:
the door as claimed in claim 12.
